(19) United States
(12) Patent Application Publication
(10) Pub. No.: US 2008/0224034 A1
(43) Pub. Date: Sep. 18, 2008

(54) System and Method for Locating One or More Persons

(76) Inventors: Devlin Stuart Wollstein, Queensland (AU); Andrei Zvyagin, Queensland (AU)

Correspondence Address: INDIANO VAUGHAN LLP, ONE N. PENNSYLVANIA STREET, SUITE 1300, INDIANAPOLIS, IN, 46204, US

(21) Appl. No.: 11/994,790

(22) PCT Filed: Jul. 6, 2006
(86) PCT No.: PCT/AU2006/000956

§ 371 Date: May 9, 2008

(30) Foreign Application Priority Data
Jul. 6, 2005 (AU) 2005903584

(51) Int. Cl. G01N 21/00

(52) U.S. Cl. 250/302

(57) ABSTRACT

An apparatus (10) for locating a subject is disclosed the apparatus includes an illumination/detection module (12) containing a source in this case a high-power laser (14) capable of radiating light at a wavelength in the infrared portion of the em spectrum. The optical output of the laser (14) is directed by beam-splitter (BS) (16) and lens (20) towards the rescue scene and a plurality of absorbers responsive to the said source disposed on the subject (22). The detection section of module (12) then collects signals radiated emitted by a plurality of emitters associated with the subject said emitters being associated with the absorbers.

### BACKGROUND OF THE INVENTION

1. Field of the Invention

The invention relates to a system and method for locating one or more subjects. In particular although not exclusively the present invention relates to a system and method the location of one or more persons via fluorescence detection.

2. Discussion of the Background Art

In many aerial search and rescue operations it can be exceedingly difficult to pin point the location of the desired target. For example in air-sea rescue operations location of missing persons is made difficulty due to the turbulent nature of the ocean's surface. Choppy seas, further compound location efforts as a person or persons can be camouflaged by surface waves.

Similar difficulties are experienced in attempting to locate lost snow skiers. As snow is often soft, people can easily fall and become partially or fully covered by a layer of snow, e.g. in a snow drift, or they may get caught in an avalanche. This snow coverage makes notoriously difficult to locate the person or persons in question. Put simply as the person is covered with loose snow they are not readily visible to a search and rescue party.

Thus the problem with current rescue techniques is that the typically rely on a search party actually visually spotting the person in the sea or snow drift etc from a helicopter or the like. After the person has been spotted and their location identified they then can be physically picked up by either a boat or from a rescue aircraft. Thus the time between the person(s) becoming lost or entering the water and their eventual rescue can be exceedingly long and increases the risk of hypothermia and exposure to animal and shark attack.

To assist rescuers various types of location beacons and transmitters have been employed, such as EHERB's, RF identification tags and the like. While these transmitters can greatly improve search and rescue response times, they utilise radio transmission and are therefore reliant upon power source such battery packs. Thus there is the potential for the transmitters to run flat and cease transmitting before a rescue party can locate the signal source. Furthermore a user can be separated from handheld transmitters such as the EHERB. In such instances the location provided by the transmitter may be meters if not kilometres away from the actual location of the missing person or persons.

In view of this a number of optical based detection systems for rescue operations have been proposed. One such system is discussed in U.S. Pat. No. 5,793,034 entitled ‘Target Detection System Utilizing Multiple Optical Criteria’. The system of U.S. Pat. No. 5,793,034 includes at least two independent pulsed laser diode sources each source having different wavelengths. The output from each source is then combined to form the incident detection beam, this beam is then trained onto the search area. The various wavelengths of the incident detection beam are then reflected by a tailored marker material disposed on the target, these reflected beams are then analysed by the system in order to determine whether a valid target has been located. The marker material is chosen so as to reflect the wavelengths of the incident detection beam while substantially attenuating all other wavelengths.

The problem with such a system is that the reflected beams may skew off at various angles and therefore the reflected beams may not always be reflected back toward the detector. As the system of U.S. Pat. No. 5,793,034 primarily relies upon the reflectivity of the marker material, reflected light from the search area also becomes a factor. As the surface of search areas such as the ocean and snow fields are highly reflective they too can readily reflect the wavelengths of the incident detection beam used to detect the target thus resulting in false detection.

Furthermore the system of U.S. Pat. No. 5,793,034 and other optical detection schemes suffer greatly from background solar radiation effects resulting in a lot of background noise which lowers detection accuracy of the system particularly during daytime operations

Clearly it would be advantageous if a way could be devised of locating a person or persons that was not reliant upon a power source to radiate a positioning signal and that would also assist the search and rescue process while lowering the considerable expense of same. Furthermore it would be advantageous to provide a way of locating a person or persons that could be used during daylight operations which substantially reduces the adverse effects of background solar noise.

### SUMMARY OF THE INVENTION

### Disclosure of the Invention

Accordingly in one aspect of the present invention there is provided an apparatus for locating a subject said apparatus including:
a source of electromagnetic radiation capable of illuminating the general area containing the subject to be located;
a first absorber associated with said subject and responsive to said radiation;
a first emitter associated with said subject wherein first emitter emits a first signal in response to absorption by said first absorber;
a second absorber associated with said subject and responsive to said radiation;
a second emitter associated with said subject wherein second emitter emits a second signal in response to absorption by said second absorber; and
a detector capable of detecting the first and second signals and providing an output indicating to the location of said subject.

In another aspect of the present invention there is provided a method of locating a subject, the method including the steps pf:
providing said subject with a first absorber selected to absorb incident electromagnetic radiation of a selected frequency;
providing said subject with a first emitter selected to emit first signal in response to illumination of said absorber by said incident radiation;
providing said subject with a second absorber selected to absorb incident electromagnetic radiation of a selected frequency;
providing said subject with a second emitter selected to emit a second signal in response to illumination of said absorber by said incident radiation; and
detecting said first and second signals and providing an indication upon detection of said signals

Preferably the method includes actively illuminating the subject with a radiation source capable of illuminating the general area in which the subject is expected to be found. This may be done by flooding the field of view or by scanning a narrow beam of radiation across the search area. In either case the radiation generated by the source is emitted in the general direction of the subject to be located.

Upon striking the subject a portion of the energy of the incident radiation is absorbed by the absorbers. The absorbed energy then causes the emitters to spontaneously emit separate return signals each of differing wavelengths and each having a longer wavelength (and thus lower frequency) to that of the radiation source. This difference between the wavelength of the source and each of the return signals know as the Stokes shift is utilised by the present invention differentiate the return signals from sources of background radiation.

The source and detector may be housed in a single unit, wherein the source and detector are positioned adjacent each other within the unit. Alternatively the source and detector may be provided as separate units. Of course the absorber and the emitter are naturally separate from these components and are associated with the subject to be located, e.g. on the surface of an article of clothing or the like worn by the subject.

The device may be a handheld device, such an arrangement enables a searcher to actively control the illumination of the search area or path by the source. Alternatively the device is vehicle mounted so as to allow a searcher to cover a large search area relatively quickly. Upon receipt of the return signals the device indicates such receipt to the searcher with the direction in which the device is pointed broadly indicating where the subject is located.

The source may be pulse modulated wherein the modulation (pulse rate) is controlled by a signal generator couple to the source. Modulating the source in this manner also effectively modulates the return signals emitted by the emitters. Suitably the source is capable of delivering em radiation in one of a variety of forms. For example the source may be a visible, UV, infrared or near infrared light source. Preferably the source is a laser diode. It will however, be appreciate that radiation source may be a radiation source utilising any part of the em spectrum.

The source may further include at least one filter and/or hot mirror mounted at an angle to the direction of the source, e.g. 45 degrees to the direction of the source. The source may further include means for directionally focussing the emitted radiation toward the search area, such as a collimator. The filter and/or hot mirror may be located forward of the laser diode.

The detector may comprise a receiving lens, having a suitable focal length being arranged in an appropriate spatial relation to a receiver. The lens acting to focus the return signals onto the receiver. The receiving lens may be sized and shaped so as to form a real image of the subject on the receiver.

The receiver may be a photo receiver, comprising one or more photo diodes, e.g. PIN photo diodes, arranged on the surface of the receiver. The receiver may further include an amplifier such as a trans-impedance amplifier form amplifying the electrical output of said photo diodes prior to further processing.

The device may also include means for differentiating the return signals from signals emitted by background radiation sources incident upon the detector. The differentiating means may comprise a filtering means for filtering out radiation components which are not in phase with the modulated return signals. The filtering means may be a bandpass interference filter and/or long wavelength pass coloured glass filter. Suitably the band-pass filter has a minimum passband of 20 nanometres. It will of course be appreciated that the passband of the band-pass filter is tuned to accommodate the spectral separation between the first and second return signals. For example the passband of the filter could between 20 to 70 nm, 70-120 nm, 120-170 nm or 170 to 220 nm in order to accommodate the spectral separation between the first and second return signals, with the spectral separation between the two return signals being dependent upon the characteristics of the selected emitters.

The filtering means may also include an aperture stop for limiting the field of view of the receiving and processing means to thereby screen out signals emanating from outside the field of view. Preferably the aperture stop is a variable iris aperture that is mounted in a fixed in relation to the source. Preferably the field of view of the aperture corresponds substantially with the field of view of the source. Alternatively the field of view may be a wide search area particularly in the case of when the device is mounted on a moving vehicle. The filtering means may further include a long wavelength pass coloured glass filter permitting only a predetermined wavelength of light to pass therethrough.

The detector may comprise means for processing the modulated return signals outputted from the receiver. Suitably the processing means includes a phase sensitive amplifier or lock-in amplifier. Each of the modulated return signals is demodulated by the phase sensitive amplifier to produce an averaged DC signal for each pulsed input. The phase sensitive amplifier produces this averaged DC signal by multiplying the signal from the receiver by a balanced bipolar square-wave reference, and then averaging this out over a time interval, e.g. 1 or more seconds, preferably 1 second. The phase sensitive amplifier may utilise a reference signal for the pulsed excitation beam from the signal generator that is coupled to the diode laser.

Thus the phase sensitive amplifier operates as an extremely narrow band filter that eliminates substantially all noise spectral components other than those components that are in phase with the modulation frequency of the source (i.e. detector employs synchronous detection). Use of the phase sensitive amplifier gives a very high signal to noise ratio thereby enhancing the reliability of the device.

Another benefit of modulating the return beams in this manner is that it shifts the signal bandwidth above the 1/f noise spectrum of the trans-impedance amplifier electronics.

The processing means may further include means for amplifying the output DC electric signal from the phase sensitive amplifier above a predetermined threshold. Suitably the threshold is set well above the noise level of the system so that the potential for false activation of the indicator is further reduced.

The device may include an indicator for specifically indicating when the subject has been located. The indicator may be energised to activate or trigger when the signal from the phase sensitive amplifier exceeds a certain level, e.g. indicating detection of the return beams from the florescent coatings.

The indicating means may be a visual indicator such as a visual display unit, monitor, flashing light or the like. Preferably visual indicator is a bright light or a flashing light. The visual indicator may be an LED, e.g. a red or green LED indicator. The indicating means may also include audible alarms in the form of a beeper, buzzer, siren, hooter or the like, most preferably the audible alarm is in the form of a beeper.

Suitably the first absorber and emitter are in the form of a first fluorescent coating which is applied to the surface of an article worn by the subject and the absorber and emitter are in the form of a second fluorescent coating. Preferably the second fluorescent coating is applied over the first fluorescent coating such that the energy from the source is absorbed and retransmitted at differing wavelengths buy both layers almost instantaneously. Alternatively the first and second fluorescent coatings may be applied in various patterns such as a chequered board arrangement over the surface of an article to be worn by the subject. Consequently the source is chosen with a wavelength at which is readily absorbed by the fluorescent coatings that are chosen to coat the article. Preferably the source has a wavelength of 750 nm to 1000 nm. Conveniently one of 785 nm, 850 nm or 980 nm may be chosen.

Thus in this embodiment the fluorescent coatings are used to absorb the energy incident from the source and then radiate two distinct beams of differing wavelengths. An advantage of this embodiment is that it is a relatively easy matter to coat an article worn by the subject with both fluorescent treatments, e.g. they may simply be painted on, sprayed onto the chosen article. Alternatively the coating could be applied by impregnating the article with the chosen fluorescent materials, or by producing polymer or fabric that is already doped with the appropriate fluorescent material.

One example of a suitable coating is 3-diethylthiadicarbocyanineiodide (TDCI) was used at the fluorescent coating. Another suitable coating is 1,1′,3,3′,3′-hexamethylindodicarbocyanine Iodide (HIDCI) was used as the fluorescent coating. Both dyes exhibit strong absorption in the infrared region giving them characteristic blue and blue-green colours. Further both dyes showed strong florescent emission, e.g. for the return beam consistent with their high quantum yield. Advantageously the selected coatings are relatively transparent when applied to an article of clothing or the like and do not tend to interfere with the overall aesthetic appearance of the garment. An example of another suitable fluorescent coating is ELF® 97 manufactured by Molecular Probes Inc, 29851 Willow Creek Road, Eugene, Oreg. USA. ELF® 97 is a UV fluorescable dye which exhibits emission in the infrared or near infra red. It will however be appreciated that any suitable fluorescent coating that strongly absorbs energy in the range of the excitation beam could be used, and that the above dyes are but examples of such suitable fluorescent coatings.

Accordingly the passband of the band pass filter in this instance is set to attenuate light falling outside the portion of the spectrum in which the emission maxima of the first and second fluorescent coatings lie. In this way only a limited wavelength of light corresponding to the return beams are allowed to reach the receiver. In the case of a system utilising a combination of TDCI/HIDCI the passband is in the order of 20 nm while for a TDCI/ELF®97 combination the passband is in the order of 150 nm.

It will be appreciated that the design specifications of filters for the device depend on the characteristics of the chosen source and emitter materials. The filters associated with the source will be specifically chosen to let the wavelength of light corresponding to the wavelength of the source and attenuate all other extraneous wavelengths. The filters associated with the receiver by contrast will be chosen to admit wavelengths in the portion of the spectrum in which the return signals are emitted by the emitters. Thus the filters for the system can only be specified once the wavelength of the source and the emitters are chosen. Accordingly the various properties of the filters will vary for different systems having different source and emitter combinations.

According to yet another aspect of this invention there is provided a method of locating a subject within a given search area using the apparatus described above, comprising:
providing the subject to be located with a means for receiving an excitation beam of em radiation and absorbing this radiation and then radiating out a first and a second return beam said first and second beams having altered characteristics relative to the excitation beam and each other;
providing a device including an excitation beam generating means, a return beam receiving means and a filtering means and processing means;
training the device in the general direction of the search;
moving the device around the search area until the device indicates that it has received the first and second return beams; and
noting the general position at which the device was pointed when said indication was received and retraining the device to the noted position to confirm the location of the subject.

The method may include keeping the device trained on the position of the subject to enable the searcher to hone in on the subject, e.g. causing a repeated indication, e.g. flashing and beeping of the device.

The method may be used to locate a person in the sea who needs to be rescued. The method may also be used to locate a person covered in snow who needs to be rescued. In such applications the method may include moving the device back and forth in disciplined passes or sweeps to systematically cover a search area. It may also include using a plurality of said devices together in a systematic and disciplined manner.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic view of an apparatus for locating a subject according to one embodiment of the invention.

FIG. 2 is a schematic illustration of the use of a hand held version of the apparatus of FIG. 1;

FIG. 3 is a schematic illustration of the use of a vehicle mounted version of the apparatus of FIG. 1

FIG. 4 is a graphical representation of the passband for the gated detection arrangement for use on the apparatus of FIG. 1;

FIG. 5 shows side by side the absorption and emission spectra of one example fluorescent coating namely HIDC; and

FIG. 6 shows side by side the absorption and emission spectra of another example fluorescent coating namely TDCI;

FIG. 7 shows side by side the absorption and emission spectra of another example fluorescent coating namely ELF® 97

### DESCRIPTION OF EMBODIMENTS OF THE INVENTION

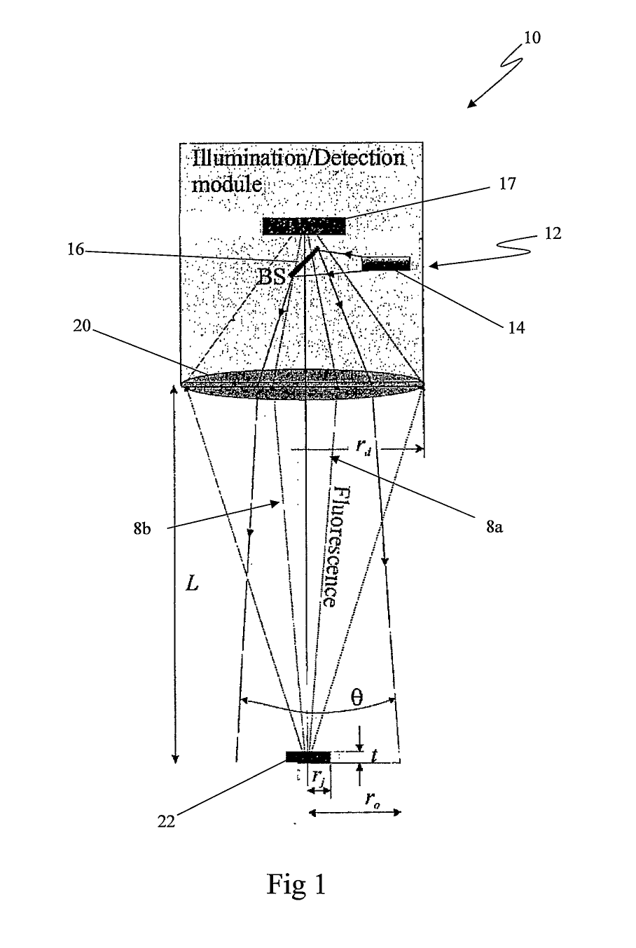

With reference to FIG. 1 there is illustrated one possible configuration of the location apparatus according to an embodiment of the present invention. The apparatus 10 generally includes an illumination/detection module 12. The illumination section module 12 contains a source in this case a high-power laser 14 capable of radiating light at a wavelength in the infrared portion of the em spectrum. The optical output of the laser 14 is directed by beam-splitter (BS) 16 and lens 20 towards the rescue scene and the absorbers associated with the subject 22.

With the configuration as shown in FIG. 1 the whole scene can be illuminated at once and as such is termed full-field illumination. Alternatively, it can be illuminated in scanning manner, i.e. rastering a conditioned laser beam across the sea surface by using two scanning mirrors. In both cases the total view of the search area is assumed equal.

The detection section of module 12 is designed to collect fluorescent radiation emitted by the emitters, which in this case are in the form of fluorescent coatings disposed on the subject. In the full-field configuration, the detection module comprises detection optics having a lens, and a TV or CCD camera preferably of high detection sensitivity. In the scanning configuration the detection module comprises a lens and a photo-receiver positioned behind on or more scanning mirrors.

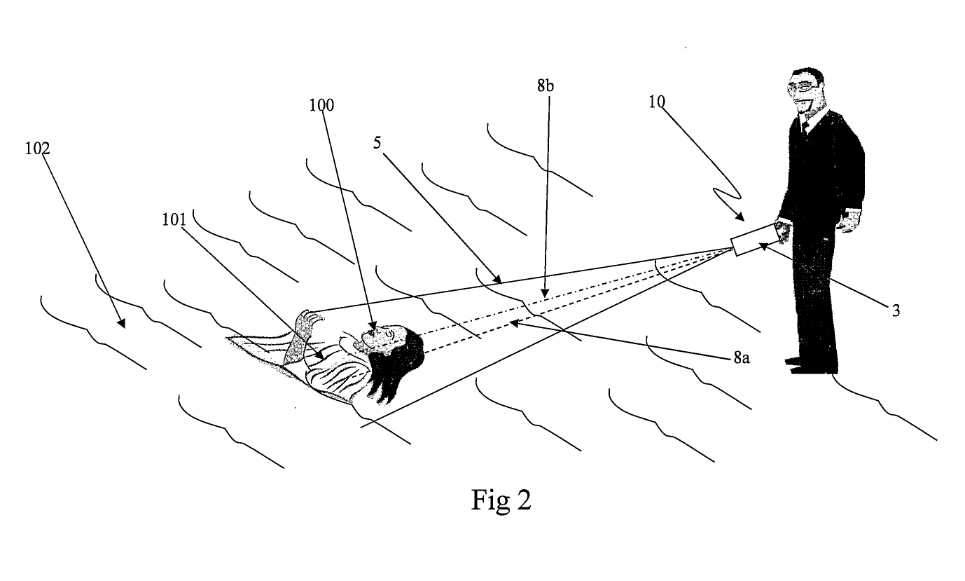

FIG. 2 illustrates one application of the location apparatus 10 according to one embodiment of the present invention. In this instance the location apparatus 10 is in the form of a handheld unit 24. The hand held unit comprises a housing 3 containing means for radiating a source in this case a laser diode capable of radiating light at a wavelength in the infrared portion of the em spectrum.

The device also includes a detector for detection of a first return beam 8a and second return beam 8b emitted from the subject 100 whom in this instance has been covered by a snow drift 102. The first return beam 8a and a second return beam 8b are reflected back to the handheld unit 24 by the fluorescent dyes disposed on the outer surface of the subjects jacket 101. It will be appreciated however that the subject's jacket could be coated with more than two dyes to further improve the detection response of the system. The handheld unit 24 also includes return beam filtering means in the form of a narrow bandpass filter for filtering out incident sunlight reflected form the surface of the search area 102 from that of the return beams 8a and 8b. The minimum spectral width of the filter passband is approximately 20 nm but this can vary depending on the spectral properties of the fluorescent coatings which applied to the subject.

The handheld unit also includes processing means for processing the signal that passes through the filter and finally also indicating means in the form of a beeper and a flashing light for indicating that the subject 100 has been sensed by the handheld unit 24. By virtue of the direction in which the handheld unit 24 is pointed at the time that it beeps the searcher 103 is given a general indication of where the subject 100 is located beneath the snow drift 102.

The device may include a collimator for collimating excitation beam 5 from laser diode 4 to produce a beam with a certain beam width profile. The source may also include a hot mirror mounted at an angle to the direction of the excitation beam 5, e.g. 45°, and a bandpass filter to suppress any spontaneous background emission at longer wave lengths. This is important because such spontaneous radiation cannot be distinguished from the return signals 8a and 8b.

The hot mirror may be an Edmund optics 43.955 hot mirror and the pass filter may be an Edmund optics 1650 nm short wavelength pass filter.

The laser diode may be coupled via laser driver to a signal generator. The signal generator is then used to modulate the laser diode to produce a pulsed signal.

Finally the source may also include a beam expander in the form of a telescopic barrel assembly for expanding the excitation laser beam up to a desired diameter.

The detector includes a receiving lens 20 for focusing the return beams onto the photo receiver 17 comprising a plurality of silicon photo diodes. Receiver 17 then converts the received optical signals into corresponding electrical signals then passed to a transimpedance amplifier. The responsivity of the photo diodes within the receiver at 690 nm is about 0.4 A/W. The transimpedance gain is about 1.0×10⁶ V/a giving an overall response of 0.4 V/μW at this wavelength. The linear range of the amplifier is 10 volts and thus the ambient light reaching the photo receiver must be limited to less than the saturation level of 25 μW.

The detector also includes the filter for filtering out background light emissions from the search area. The filter in this instance is a band-pass interference filter centred at about 700 nm with a pass-band of 20 nm. The detector may also include a wavelength pass coloured glass filter for admitting the appropriate wavelengths of the return. These filters perform the important function of selectively admitting the fluorescent light of the return beams to the photo receiver 17 and screening out the reflected sunlight from the search area's surface and any sunlight that is incident on the receiving lens 20.

In summary the filters and are designed to permit only a range of wavelengths in the portion of the em spectrum in which the return beams are emitted through to the photo receiver 17.

The receiving lens 20 may form a real diminished image of the subject on the photo detector 17. The receiving means further includes a variable iris aperture to further restrict and block em radiation other than that in the return beam emitted by the fluorescent coating. The variable iris aperture is precisely aligned with laser field of view so as to only admit radiation issuing in a straight line from the field of view into the receiving means. Further the variable iris aperture is very carefully aligned to coincide with the laser field of view and is also closed down to nearly match the size of the image of the subject to be located so as to permit light from the field of view to enter the receiving means but to screen out all other light.

The photo receiver 17 is a commercially available general purpose photo receiver such as a Thorlabs PDA520. Suitably the photo receiver 17 has a large area silicon photodiode and integral transimpedance amplifier.

The unit 24 also includes processing means in the form of a phase-sensitive or lock-in amplifier that is used to demodulate the pulsed fluorescent signal in the return beams 8a and 8b coming from the subject 100 beneath snow drift 102. In essence the return beams 8a and 8b are pulsed at the same rate as the excitation beam 5 and the reference details can be obtained from the signal generator for the excitation beam 5. In brief the lock-in amplifier works by multiplying the receiver signal by a balanced by-polar square-wave reference and then averaging this out over a long time constant e.g. of one or a few seconds. As the receiver signal from the return beam is modulated or pulsed at the precise frequency of the reference, the multiplication gives rise to an average or DC output signal.

In essence the lock-in amplifier operates as an extremely narrow filter that eliminates all but in-phase noise spectral components at the modulation frequency and gives a very high signal-to-noise ratio. The DC output signal is then amplified to a level at which it is able to activate or trigger an indicating means.

The handheld unit 24 also includes an indicating means in the form of a visual and audio indicator. Specifically the indicator comprises LED devices that emit a flashing light when activated as well as a beeper that beeps when activated.

The outputted DC signal from the lock-in amplifier is amplified to a level appropriate to trigger or activate the audio and visual indicator when it receives the return beams 8a and 8b from the respective fluorescent coatings disposed on the jacket. An adequate detection threshold can then be set well above the noise level system so that the risk of false triggering by system noise is low.

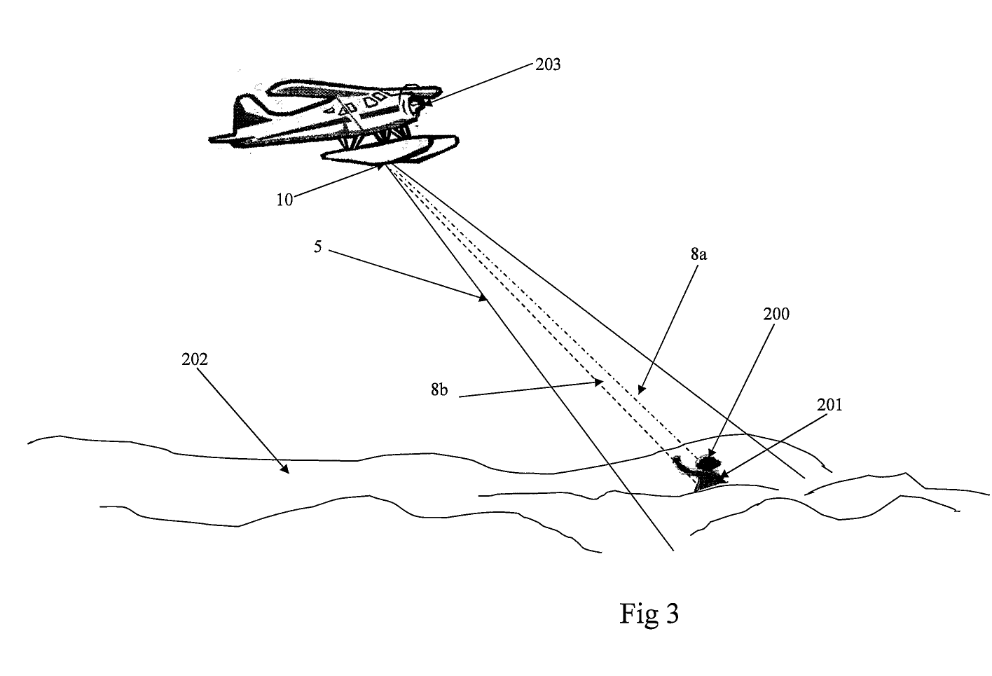

In FIG. 3 there is illustrated a further application of the location apparatus 10 of FIG. 1 in this instance the apparatus is mounted on a search aircraft 203. Alternatively the location apparatus 10 could be mounted on a light house (or cliff) should it is able to detect a floating fluorescence-coated object floating on the ocean's surface.

As discussed above the apparatus 10 generally includes an illumination/detection module 12. The illumination section module 12 contains an excitation beam source in this case a high-power laser 14, capable of radiating light at a wavelength in the infrared portion of the em spectrum. The optical output of the laser 14 is directed towards the rescue scene and the subject 22 via a beam-splitter (BS) 16 and lens 20.

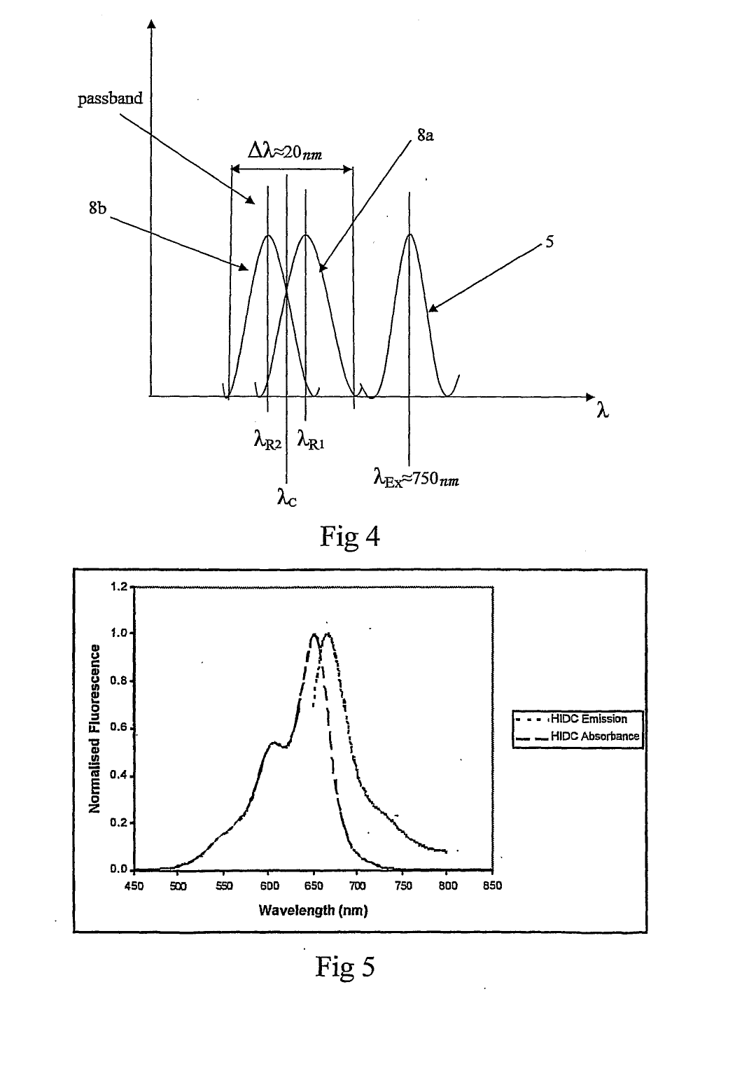

Excitation beam 5 from laser 14 is directed generally toward the search area 202 in this case the surface of the ocean toward subject 200. Upon the illumination of the subject 200, a first return beam 8a, and a second return beam 8b are reflected back to the apparatus 10 by the fluorescent dyes disposed on the outer surface of the subjects jacket 201. It will be appreciated however that the subject's jacket could be coated with more than two dyes to further improve the detection response of the system. The location apparatus 10 also includes return beam filtering means in the form of a narrow bandpass filter for filtering out background solar radiation from the return beams 8a and 8b. The minimum spectral width of the filter passband is approximately 20 nm but varies depending on the spectral properties of the fluorescent coatings which applied to the subject see FIG. 4.

The detection of a person on the surface of the ocean however poses a number of possible problems. For example the myriad of micro-organisms that populate the surface layers of the ocean can fluoresce and emit light in visible wavelength range which generates further background noise. In addition the constant positional changes of the vehicle as place additional burdens on the sensing process. To this extent the applicant has trialled two detection processes a continuous wave (CW) approach and pulsed illumination combined with synchronous gate detection (SPID) approach similar to that used in commercial lidar systems.

### Continuous Wave (CW) Approach

Under the CW approach the key design equation for the detection system is as follows:

$${W}_{d} = {W}_{0} t ɛ {c}_{M} η \cdot {( \frac{{r}_{d} {r}_{j}}{2 {L}^{2} tan [ θ \text{/} 2 ]} )}^{2} , \qquad ( 1 )$$

for power incident on a single camera pixel. θ stands for the divergence angle of the illumination light beam. c_{M} denotes the molar concentration of the fluorophore layer [moles/litre], t symbolizes the layer coating thickness, and ε is an important parameter termed the molar extinction coefficient [l/mol.cm] that determines the absorption efficiency of fluorophore. W₀ is the total power emitted by the laser, rⱼ is the mean radius of the fluorescent jacket, and r_{d} denotes the radius of the detection optics aperture. L is the height of the rescue aircraft 203 from the sea surface 202. The absorbed light is converted to fluorescence light radiation, and this conversion efficiency is called the quantum efficiency η. r₀ is the radius of the illumination field on the sea surface, expressed as r₀=2L tan [θ/2]≅Lθ at small angles. The CCD camera is used to capture an image of the search area in a single shot. N stands for total number of pixels on the CCD camera. The signal on the CCD camera is expressed in terms of number of photoelectrons φ, integrated over the exposure time τ:

$$φ = {W}_{0} t ɛ {c}_{M} η \cdot {( \frac{{r}_{d} {r}_{j}}{2 {L}^{2} tan [ θ \text{/} 2 ]} )}^{2} ρτ , \qquad ( 2 )$$

where ρ=η_{CCD}/hv is the camera photoresponsivity, η_{CCD} is the conversion efficiency, hv is the photon energy. As one can see, number of photoelectrons, and hence the ultimate sensitivity of the system depends on many parameters. In this calculation, a large laser power of 1 W has been assumed, and large detection aperture of the collection lens of 1 m in diameter, which favour the high sensitivity of the system at night. The other parameters used in this calculation are summarized in Table 1 below. The number of detected photoelectrons (pe) per pixel is estimated to be about 10⁸ pe. Here, we have assumed the CCD sensor area of 500×500 pixels that results to the fluorescent object size of roughly one pixel, the optimal detection condition.

TABLE 1

| | | |
|---|---|---|
| Light source, power, W₀, mW | 1000 | High-power laser source |
| Molar absorption, ε, liter/ | 7.4 × 104 | Typical for good dye |
| mole · cm | | |
| Molar concentration, C_{M}, mole/ | 3 × 10⁻³ | |
| liter | | |
| Quantum efficiency, η | 1 | Typical |
| Conversion efficiency, η_{CCD} | 0.6 | Typical at infrared |
| Coating layer thickness, t, μm | 10 | Applied by spraying |
| Coating layer radius (jacket), cm | 10 | As viewed from above |
| Ranging length, L, m | 300 | Low flying |
| Illumination beam divergence | 9 | Easy to control |
| angle, θ, deg | | |
| Effective radius of the illumina- | 50 | |
| tion field, r₀, m | | |
| Aperture radius of the detection | 40 | |
| module, r_{d}, cm | | |
| Exposure time, τ, s | 1 | Easy to control |
| Wavelength bandpass filter | 20 | |
| width, Δλ, nm | | |

### Detection Sensitivity at Night Time

The noise figure for high-end CCD cameras is roughly 12 pe that results to the detectable signal-to-noise ratio (SNR) of roughly 10⁷ pe. Note that a rescuer views the area of 100-meter in diameter for one second, assuming the possibility to fix the illumination beam with respect to the sea surface. Increasing flying height to 1000 m results to the SNR drop of approximately 100 times that indicates critical dependence of the system sensitivity versus aircraft 203 flying height. The view area is increased to 300 m in diameter. Since we have assumed a very thin dye layer and SNR is large, there exist some margins to ease the technical requirements to the system, e.g. decrease the lens diameter, decrease acquisition time, so that dynamic scene viewing is enabled, or increase the illumination angle to view greater fragments of the sea surface. Based on the presented estimates, it may to be possible to detect a fluorescent object at night time, e.g. a rescue wearing a jacket with reasonable area of 20 cm in diameter, as viewed from the airplane. The detection lens diameter of 1 m is achievable. No other light sources, but the fluorescent object, are assumed in the calculation, although under real conditions, there may be moon/star light, reflection of the laser light from the sea surface, intrinsic fluorescence from the sea surface, etc. The laser 14 in this instance has chosen wavelength in the near-infrared range (650 nm-1550 nm) to avoid the sea fluorescence originating from myriads of micro-organisms that populate the surface layers of the ocean. In the near-infrared range, the spectral environment is “quiet”. Thus the coating dyes are chosen such that strongly absorb this near infrared excitation beam 5 and re-radiate the appropriate return beams 8a and 8b.

### Detection Sensitivity at Day Time

Considering the operation of the at day time, background solar radiation presents a significant problem. The estimated the photoelectron number at a single pixel of the CCD camera under typical day light conditions as:

φₛ= [symbol] _{datasheet}×πrⱼ²(r_{d}²/L²)Δλρτ/2, (3)

The spectral reflection of sunlight from the sea surface to be a dominant contribution to the background solar radiation. [symbol] =1.1 [symbol] m2 .nm⁻¹ is the tabulated value of the solar irradiance at a wavelength of λ=750 nm. A narrow wavelength passband filter of Δλ=20 nm is assumed to reduce the amount of the solar radiation at the detector. Substituting the reasonable system parameter values into Eq. (3), we obtain [symbol] =2.3×10¹³′τ; where we recall i is the CCD camera exposure time. Assuming maximum well depth of the CCD camera, i.e. maximum number of photoelectrons each pixel can detect before saturation, φₘₐₓ=100,000, one needs to reduce the integration time from 1 second, as for the night-time condition, to 5 ns to avoid the CCD camera saturation by the background solar radiation. As Eq. (2) shows, the signal value becomes 0.5 pe, i.e. non-detectable considering the CCD camera intrinsic noise of 12 pe. The shot noise associated with such large solar background exacerbates the situation by generating considerable noise of [symbol] =φₛₒₗₐᵣ [symbol] =\sqrt{φₘₐₓ}=316 pe, so that the overall SNR budget represents a small signal of 0.5 pe that is buried in noise comprising 12 pe of intrinsic CCD noise and 316 pe shot noise.

In view of the above estimations, it is difficult to locate a floating fluorescent object on the sea surface at day time from the aircraft 203 using CW laser radiation approach and the full-field detection configuration, i.e. using a CCD camera.

### SPID Approach

It is possible to improve the SNR of the system by employing SPID approach. In brief, a short-pulsed, preferably nano-second pulsed, laser is employed, which output is rastered across the sea surface via two mechanical scanners based on, e.g. galvanometer-mounted mirrors. A single optical pulse emitted by the laser travels to the fluorescence object, excites it, and a short pulse of fluorescence radiation is emitted whose small fraction is collected by the detection system, now comprising a single PIN photoreceiver compounded by the synchronous gated detection electronics. It is possible to open a detection gate of the detector only for a very short duration of time commensurable with the fluorescence pulse width to detect the full power of the useful fluorescence signal. In this instance the gated detection electronics are calibrated to allow a 20 nm passband of optical frequencies as shown in FIG. 4. The amount of the detected background solar radiation is, therefore, greatly reduced.

Re-calculating the signal at the detector in terms of number of photoelectrons. A nanosecond-pulsed infrared lasers can generate 20 Watts of optical power in succession of 100 pulses per second, (i.e. duty cycle of τ_{dc}=10 ms), where the single pulse width amounts τₚᵤₗₛₑ=10 ns. Assuming that the total scanned area is the same as in the previous calculation, i.e. 100 m in diameter, which is now divided into roughly 10×10 squares, so that the elementary surface area viewed during a single laser pulse shot is very roughly 100 m². The number of photoelectrons φ_{sc} then given by

$${φ}_{sc} = {W}_{0} {τ}_{dc} t ɛ {c}_{M} η \cdot {( \frac{{r}_{d} {r}_{j}}{2 {L}^{2} tan [ {θ}_{sc} / 2 ]} )}^{2} ρ , \qquad ( 4 )$$

where θ_{sc} stands for the reduced illumination angle θ_{sc}≅θ/10. Substituting appropriate values in Eq. (4), φ_{sc}≅2×10⁹ pe, which is somewhat greater than that of the previous case of the full-field detection. The main advantage of this detection scheme, though, becomes evident when the number of photoelectrons produced by the solar radiation is estimated using Eq. (3):

φ_{s,sc}=ρτₚᵤₗₛₑWₛ. (5)

The number of photoelectrons is now only φ_{s,sc} 200,000 pe, which is acceptable considering a conventional PIN diode characterized by the large photoelectron well depth, as opposed to the much smaller well depth of a typical CCD camera. The associated shot noise is now only 450 pe, and combining Eqs. (4) and (5), the SNR is evaluated as:

SNR_{sc}=φ_{sc}/ [symbol] φ_{s,sc} [symbol] =4×10⁶, (6)

which represents a marked improvement over the full-field configuration, One need to take into account that the full scan takes 1 second, i.e. the same time, as that used for the full-field configuration to integrate the signal. In order to refine the scan grid, i.e. make the pixel size smaller, the system parameters should be optimized. It seems very plausible, since the SNR margin is large.

The fluorescent materials used to coat the item of clothing worn by the subject will now be discussed. In the example embodiment this article is a jacket which is coated with a thin coating of the fluorescent material. As discussed above the fluorescent material is necessary to absorb energy from the excitation beam and then reradiate or emit this energy in the form of a return beam having certain specific properties that are a function of the excitation beam and the fluorescent material and that thereby enable the return beam to be identified.

The coating could be applied in the form of a polymer dye that can be applied to the jacket for example by immersing the jacket in the dye, painting the dye on to the jacket or spraying the dye on to the jacket. The dye may be cured by UV once it is applied to the garment. Further the dye should preferably not be bleached by normal solar radiation and thus should have a sufficiently short radiative half life.

The thicknesses of the dye layers can be increased further by impregnating dye into the jacket fabric, thus improving the system performance, or by producing polymer fabric that is already doped with the appropriate dye that is more durable and can be kept longer in dark conditions. The chosen, dye should survive significant bleaching for a day or two, i.e. for the duration of the rescue operation.

Accordingly one example of a suitable coating is 3-diethylthiadicarbocyanineiodide (TDCI) was used at the fluorescent coating. Another suitable coating is 1,1′,3,3′,3′-hexamethylindodicarbocyanine Iodide (HIDCI) was used as the fluorescent coating. Both dyes exhibit strong absorption in the infrared region giving them characteristic blue and blue-green colours. Further both dyes showed strong florescent emission, e.g. for the return beam consistent with their high quantum yield. An example of another suitable fluorescent coating is ELF® 97 manufactured by Molecular Probes Inc, 29851 Willow Creek Road, Eugene, Oreg. USA. ELF® 97 is a UV fluorescable dye which exhibits emission in the infrared or near infra red. It will however be appreciated that any suitable fluorescent coating that strongly absorbs energy in the range of the excitation beam could be used, and that the above dyes are but examples of such suitable fluorescent coatings.

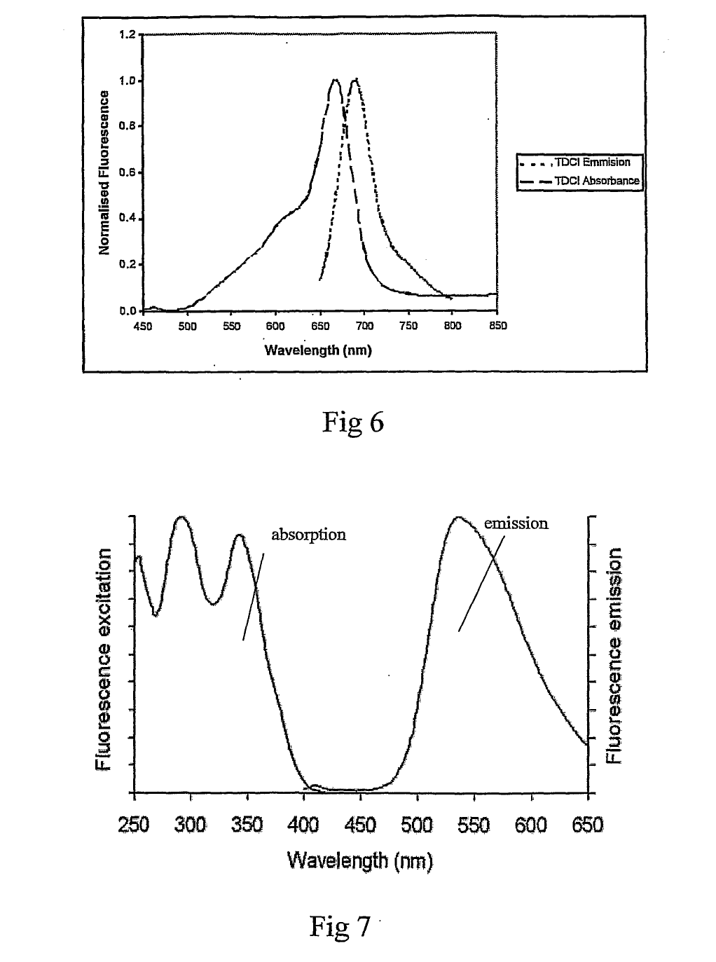

The absorption spectra of both the TDCI, HIDCI and ELF® 97 dyes are shown in FIGS. 5, 6 and 7 respectively. The TDCI, HIDCI dyes show strong absorption in the wavelength of red light giving them the characteristic blue and blue-green colours, while ELF® 97 strong absorption in the upper UV bands. Further each dye has a high molar absorption coefficient which is important because it is this absorbed energy which is then reradiated as the return beam. The dyes exhibit strong emission with high quantum yields in either the IR or near IR bands. Knowing the wavelength at which excitation occurs and the difference between the emission and absorption maxima of the selected dye, which is know as the Stokes shift allows both the source and detector to be tuned to further minimise the risk of a false reading.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1-44. (canceled)

45. An apparatus for locating a subject, said apparatus including:
a source of electromagnetic radiation capable of illuminating the general area containing the subject to be located;
a first absorber associated with said subject and responsive to said radiation;
a first emitter associated with said subject wherein first emitter emits a first signal in response to absorption by said first absorber;
a second absorber associated with said subject and responsive to said radiation;
a second emitter associated with said subject wherein second emitter emits a second signal in response to absorption by said second absorber; and
a detector capable of detecting the first and second signals and providing an output indicating the location of said subject.

46. The apparatus of claim 45 wherein the source radiates electromagnetic radiation in the at least one of the infrared and ultraviolet bands.

47. The apparatus of claim 45 wherein the source further includes a focusing element for focusing the electromagnetic radiation radiated by said source into a directional beam.

48. The apparatus of claim 47 wherein the source further includes a beam expander for expanding said beam to a desired beam width profile.

49. The apparatus of claim 45 wherein the source further includes at least one of a filter and hot mirror mounted at an angle of 45° to the direction of the electromagnetic radiation radiated by said source.

50. The apparatus of claim 45 wherein the detector includes at least one bandpass filter and at least one wavelength pass filter.

51. The apparatus of claim 50 wherein said bandpass filter has a passband between 20 to 220 nm.

52. The apparatus of claim 45 wherein the detector further includes an aperture stop and a receiving lens.

53. The apparatus of claim 52 wherein the receiving lens is shaped, sized and positioned so as to form a real image of the subject on said detector and said aperture stop is a variable iris.

54. The apparatus of claim 45 wherein the apparatus further includes an amplifier coupled to said detector for amplifying the output of said detector above a predetermined threshold.

55. The apparatus of claim 45 wherein the apparatus further includes a signal generator coupled to said source, and wherein the signal generator pulses the electromagnetic radiation radiated by said source at a predetermined frequency.

56. The apparatus of claim 45, wherein the apparatus further includes a phase sensitive amplifier coupled to an indicator, said phase sensitive amplifier converting the output of said detector to a direct current signal, said direct current signal energizing said indicator.

57. The apparatus of claim 56 wherein said indicator means produces at least one of a first visual stimuli and a first audio stimuli.

58. The apparatus of claim 45 wherein the source is at least one of a laser diode and a high powered LED, and said detector is a photo detector.

59. The apparatus of claim 45 wherein said first absorber, said first emitter, said second absorber and said second emitter are comprised of a fluorescent material disposed on the subject.

60. The apparatus of claim 59 wherein said fluorescent material is selected such that it absorbs strongly in at least one of the infrared and ultraviolet bands, and wherein the fluorescent material is a fluorescent dye.

61. The apparatus of claim 60 wherein the fluorescent dye used for said first absorber and first emitter is 3-diethylthiadicarbocyanineiodide and the fluorescent dye used for said second absorber and second emitter is 1,1′,3,3′,3′-hexamethylindodicarbocyanine iodide.

62. The apparatus of claim 60 wherein the fluorescent dye used for said first absorber and first emitter is 1,1′,3,3′,3′-hexamethylindodicarbocyanine iodide and the fluorescent dye used for said second absorber and second emitter is 3-diethylthiadicarbocyanineiodide.

63. The apparatus of claim 60 wherein the fluorescent dye used for said first absorber and first emitter is at least one of 3-diethylthiadicarbocyanineiodide and 1,1′,3,3′,3′-hexamethylindodicarbocyanine iodide and the fluorescent dye used for said second absorber and second emitter absorbs strongly in the UV portion of the em spectrum and emits in the infrared.

64. The apparatus of claim 60 wherein the fluorescent dye used for said first absorber and first emitter absorbs strongly in the UV portion of the em spectrum and emits in the infrared and the fluorescent dye used for said second absorber and second emitter is at least one of 3-diethylthiadicarbocyanineiodide and 1,1′,3,3′,3′-hexamethylindodicarbocyanine iodide.

65. A method of locating a subject within a search area, the method including:
providing said subject with a first absorber selected to absorb incident electromagnetic radiation of a selected frequency;
providing said subject with a first emitter selected to emit first signal in response to illumination of said absorber by said incident radiation;
providing said subject with a second absorber selected to absorb incident electromagnetic radiation of a selected frequency;
providing said subject with a second emitter selected to emit a second signal in response to illumination of said absorber by said incident radiation; and
detecting said first and second signals and providing an indication upon detection of said signals.

66. The method of claim 65 wherein the steps of providing the subject with said first absorber, said first emitter, said second absorber and said second emitter includes coating the subject with a fluorescent material having a characteristic frequency.

67. The method of claim 66 wherein said fluorescent material is selected such that it absorbs strongly in at least one of the infrared and ultraviolet bands wherein the fluorescent material is a fluorescent dye.

68. The method of claim 67 wherein the fluorescent dyes are selected from the group consisting of:
(1) wherein the fluorescent dye used for said first absorber and first emitter is 3-diethylthiadicarbocyanineiodide and the fluorescent dye used for said second absorber and second emitter is 1,1′,3,3′,3′-hexamethylindodicarbocyanine iodide;
(2) wherein the fluorescent dye used for said first absorber and first emitter is 1,1′,3,3′,3′-hexamethylindodicarbocyanine iodide and the fluorescent dye used for said second absorber and second emitter is 3-diethylthiadicarbocyanineiodide;
(3) wherein the fluorescent dye used for said first absorber and first emitter is at least one of 3-diethylthiadicarbocyanineiodide and 1,1′,3,3′,3′-hexamethylindodicarbocyanine iodide and the fluorescent dye used for said second absorber and second emitter absorbs strongly in the UV portion of the em spectrum and emits in the infrared; and
(4) wherein the fluorescent dye used for said first absorber and first emitter is a fluorescent dye that absorbs strongly in the UV portion of the em spectrum and emits in the infrared and the fluorescent dye used for said second absorber and second emitter is at least one of 3-diethylthiadicarbocyanineiodide and 1,1′,3,3′,3′-hexamethylindodicarbocyanine iodide.

69. The method of claim 65 further including sweeping said incident electromagnetic radiation across a search area in order to illuminate said absorber.

70. The method of claim 69 wherein said incident electromagnetic radiation is pulsed at a predetermined frequency and the step of detecting includes filtering the detected radiation by actively attenuating radiation outside the characteristic frequency.

71. The method of claim 65 further including the step of providing an indication to a user upon detecting said emitted radiation.
